(19) United States
(12) Patent Application Publication
(10) Pub. No.: US 2005/0094346 A1
(43) Pub. Date: May 5, 2005

(54) Method for detecting an object of conducting material and corresponding sensor

(75) Inventor: Remy Kirchdoerffer, Reichshoffen (FR)

Correspondence Address: YOUNG & THOMPSON, 745 SOUTH 23RD STREET, 2ND FLOOR, ARLINGTON, VA, 22202, US

(73) Assignee: SENSTRONIC, SAVERNE (FR)

(21) Appl. No.: 10/695,786

(22) Filed: Oct. 30, 2003

(51) Int. Cl. H01H 47/00

(52) U.S. Cl. 361/143

(57) ABSTRACT

The present invention relates to a process for the detection of an object in an electrically conductive material and a corresponding sensor device.

Process characterized in that it consists in generating, by means of a consequentially supplied inductance (3), a magnetic field adapted to induce Foucault currents in said conductive material, when said object (1) is located at a suitable distance from said inductance (3), in abruptly cutting the supply and the current flowing in said inductance (3), in collecting the voltage and/or current signal induced in said inductance (3) by said Foucault currents after cutting, and in analyzing the characteristics of said signal or signals, particularly its decay, thereby to deduce information concerning the nature and/or thickness of the conductive material of the detected object (1) and/or the distance between said inductance (3) and said object (1).

The present invention relates to the field of detection, particularly the detection of objects or articles of a conductive material or containing such a material, and has for its object a process for the detection of such an object as well as a corresponding sensor device.

There already exist numerous types of sensors permitting detecting the presence of conductive objects or objects coated with a conductive material, by generating magnetic fields whose characteristics are influenced by the presence and the approach of such objects.

These generated field modifications are detected by these sensors and interpreted to deduce from them information as to the presence of an object and its position (distance) relative to said sensors.

However, these latter do not permit giving any other information on the detected object, such as particularly the nature of the conductive material or the thickness of this latter, in particular when it covers at least a portion of said object.

Moreover, the existing detectors mentioned above generally comprise oscillating circuits sensitive to variations of temperature and not permitting, because of the nature of the detection, the emplacement of the sensor in a protective housing comprising an active metallic surface.

The present invention has particularly for its object to overcome at least certain of the mentioned drawbacks.

To this end, it has for its object a process for the detection of an object, conductive material (magnetic or amagnetic), enclosing at least a portion of such material or at least partially covered with such a material, characterized in that it consists in generating, at the moment of a consequentially supplied inductance, a magnetic field adapted to induce Foucault currents in said conductive material, when said object is located at a suitable distance from said inductance, in abruptly cutting the supply and the current circulating in said inductance, in retrieving the voltage signal and/or current induced in this inductance by the mentioned Foucault currents after cutting, and in analyzing the analyzing the characteristics of said signal or signals, particularly as to their decay, to deduce therefrom information concerning the nature and/or thickness of the conductive material of the object 1 detected and/or the distance between said inductance and said object.

It also relates to a device with an inductive sensor, particularly for practicing the detection process, adapted to detect and permit the characterization at least partially of an object of electrically conductive material, enclosing at least a portion of such a material and/or at least partially covered with such a material, characterized in that it comprises principally an inductance disposed in the portion or active surface of said sensor and adapted to generate a magnetic field adapted to induce Foucault currents in said conductive material, electrical supply means for said inductance and for abruptly cutting the current circulating in said latter, acquisition means for the voltage signal and/or the current signal induced in said inductance by said Foucault currents after cutting, and means for analyzing the characteristics of said signal or signals generated by induction, thereby to deduce information relating to the nature and/or thickness of the conductive material of the detected object and/or the distance between said inductance and said object (or part of an object).

The invention will be better understood from the following description, which relates to a preferred embodiment, given by way of non-limiting example, and explained with reference to the accompanying schematic drawings, in which:

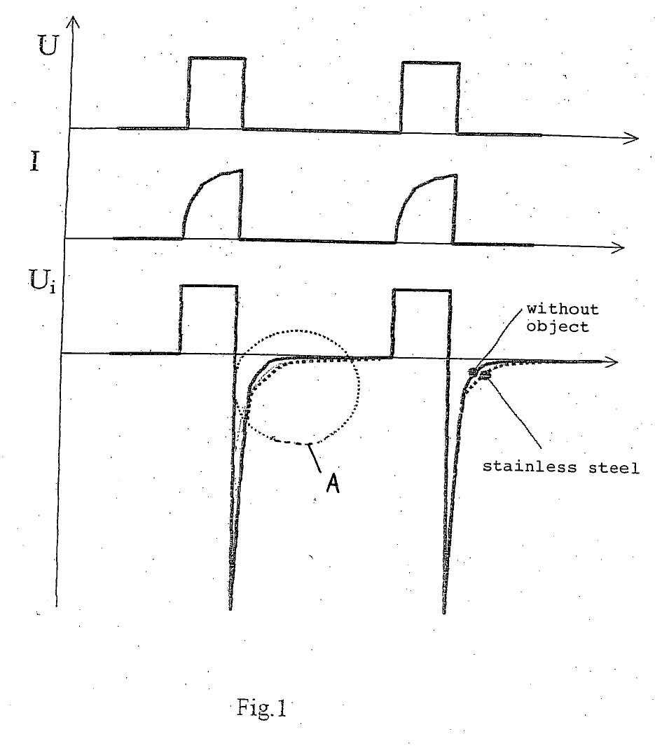

FIG. 1 shows time diagrams of the supply voltage (U) applied to the inductance forming a portion of the sensor device, of the current circulating in the inductance (I), and of the voltage applied and induced at the terminals of said inductance (Ui);

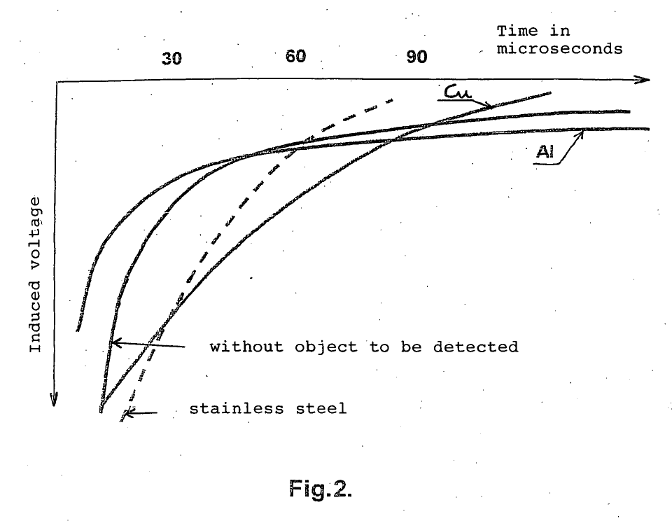

FIG. 2 shows the detail A of FIG. 1 on another scale, and

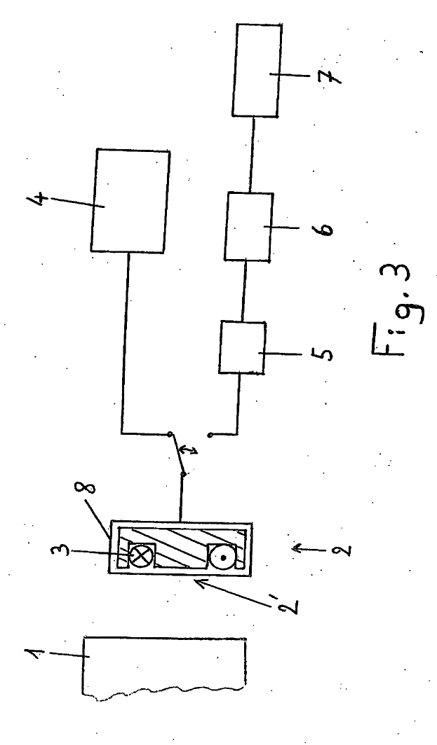

FIG. 3 is a schematic representation of an inductive sensor device according to one embodiment of the invention.

Referring to the figures of the accompanying drawings, the detection process consists essentially in generating, by means of a consequentially supplied inductance 3, a magnetic field adapted to induce Foucault currents in said conductive material, when said object 1 is located at a suitable distance from said inductance 3, in abruptly cutting the supply and the current circulating in said inductance 3, in retrieving the voltage signal and/or the current signal induced in said inductance 3 by said Foucault currents after cutting, and it analyzes the characteristics of said signal or signals, particularly its decay at the reverse peak induced by abrupt cutting of the supply current, thereby to deduce the information relating to the nature and/or thickness of the conductive material of the object 1 as detected and/or the distance between said inductance 3 and said object 1 or portion of an object.

As a function of the deduced information, one could proceed or not to the execution of an action, such as for example switching of a circuit.

So as to be able to produce continuously sequences of successive detection in real time, the supply of the inductance 3 is carried out by means of repetitive voltage pulses, the cutting of the current circulating in the inductance 3 being synchronized with the descending fronts of said pulses.

The frequency of repetition of the successive sequences of detection, determined by the frequency of the supply voltage pulses, will depend particularly on the speed of processing available for analysis and the desired rapidity of detection.

According to the invention, and as shown particularly in FIG. 3 of the accompanying drawings, the process consists in functional terms in connecting the inductance 3 to a supply unit 4, for example in the form of a pulse signal generator, during the generation phase of the magnetic field by said inductance 3 forming a field emitter means, and in connecting said inductance 3 to means 5 to 7 for acquisition and exploitation of the voltage signals induced in said inductance, for example in the form of a digitizing module, for processing and evaluation of said signals, during the magnetic induction phase, by the decreasing Foucault currents in the inductance 3 forming a field receiver means, the two mentioned phases being repeated for each impulsive signal pulse delivered by the supply unit 4.

Preferably, the acquisition of the voltage signal induced in the inductance 3 after cutting the current flowing in this latter, consists in sampling said signal over a time interval extending between 10 microseconds and 150 microseconds, preferably between 20 and 100 microseconds, after said cutting (phase preceding the cancellation of the reverse peak), and in carrying out an analog/digital conversion of the recovered samples.

The mentioned time interval permits the analysis of the portion of the induced signal supplying the pertinent information permitting deduction of the characteristics relating to the conductive material.

According to a first modified embodiment of the invention, the analysis of the characteristics of the voltage or current signal induced in the inductance 3 consists in determining the shape and position, in a time diagram, of the curve of said signal at its end or the values of at least certain predetermined points on this curve (defined by their time location relative to the instant of cutting), in comparing these characteristics with memorized reference characteristics, for example predetermined during a preliminary phase of calibration, and in deducing therefrom the nature, composition, mass and/or thickness of the conductive material of the object 1 subjected to the influence of the magnetic field generated by said inductance 3.

According to a second modified embodiment of the invention, the analysis of the characteristics of the voltage signal or the intensity induced, consists in integrating said signal over a predetermined time period of a duration and offset relative to the instant of cutting, then in comparing the resulting integrated value with memorized reference values, for example determined during a preliminary phase of calibration, and in deducing the nature, composition, mass and/or thickness of the conductive material of the object 1 subject to the influence of the magnetic field generated by said inductance 3.

So as to be able to guarantee with certainty the reliability of the deduced information, by eliminating a possible isolated erroneous detection, or if desired to reduce the frequency of repetition of the evaluation operations requiring large computing power and which would give rise to delays in obtaining the results, the process can consist in successively analyzing several induced voltage or current signals associated with several consecutive detection sequences and in making an overall evaluation of the characteristics of these different signals.

The present invention also has for its object, as shown in FIG. 3 by way of example of embodiment, an inductive sensor device 2, particularly for the practice of the mentioned detection process, adapted to detect and to permit the characterization at least partially of an object 1 which is at least partially of an electrically conductive material or at least partially covered with such a material.

This sensor device 2 comprises principally an inductance 3 disposed in the active portion or surface 2′ of said detector 2 and adapted to generate a magnetic field adapted to induce Foucault currents in said conductive material, electrical supply means 4 for said inductance 3 and for abruptly cutting the current flowing in this latter, means 5, 6 for acquisition of the voltage signal and/or of the current signal induced in said inductance 3 by said Foucault currents mentioned above, after cutting, and means 7 for analyzing the characteristics of said signal or signals generated by induction thereby to deduce information relating to the nature and/or thickness of the conductive material of the object 1 that is detected and/or the distance between said inductance 3 and said object 1.

The inductance 3 can consist of a winding with or without a core or armature of ferrite (as a function of the desired characteristics for the device 2) and have a shape and size suitable for the detection to be carried out.

Preferably, the electrical supply means 4 consist of a voltage pulse generator, preferably of rectangular shape, and in that the actuation of the cutting means for the current flowing in the inductance 3 is synchronized with the descending fronts of said pulses.

According to one characteristic of the invention, the acquisition means comprise sampling means 5 for the signal induced, taken from the terminals of the inductance 3 after cutting the current, and means 6 for analog/digital conversion of the samples provided by the mentioned means 5.

According to another characteristic of the invention, the analysis means 7, for example in the form of a computer unit, comprise means for determining the shape and position of the time curve representative of the signal induced and taken from the terminals of the inductance after cutting, comparison means for said characteristics with memorized reference characteristics, and means for deducing the nature, composition, mass and/or thickness of the conductive material of the object 1 subject to the influence of the magnetic field generated by said inductance 3.

Thanks to the manner of detection used by the invention, at least the inductance 3 can be mounted in a casing or protecting housing 8 that is hermetically sealed, preferably in stainless steel or a similar metallic alloy.

The deformation or offset of the analyzed induced signal, caused by this metallic envelope 8, can be estimate in a calibrating phase of the sensor device 2 and be taken into account during the analysis operations of the signals in the detection phases.

The invention will now be described in greater detail in its manner of operation and in relation to the accompanying drawings.

The single inductance 3 mounted frontally in the active surface 2′ of the sensor device 2, plays the role both of an emitter and of a receiver of the magnetic field.

In the course of a first step of a detection sequence according to the invention, the voltage pulse U applied to the winding 3 forming the inductance, induces in this latter a current pulse I which, in its turn, induces the magnetic detection field in the active frontal direction of the sensor device 2 (see FIG. 1). This magnetic field induces Foucault currents in the conductive target object when this latter enters into the region covered by said field.

In a second step, the current in the inductance 3 is cut or canceled abruptly (vertically descending front in the current signal I—see FIG. 1) and the Foucault currents flowing the in the object 1 or in the conductive portion of this latter at this moment, decrease toward complete annulment. Having done this, they induce a voltage in the inductance 3 forming a receiver, which is added to the self-inductance voltage (see curve Ui of FIG. 1).

Generally speaking, the duration of a detection sequence (for establishing the magnetic detection field to the canceling of the voltage induced in the inductance) is generally comprised between 100 and 200 microseconds.

A more detailed study of the phenomenon on which the invention is based, has shown that, in an unexpected and surprising way, the decay of the induced voltage takes place differently according to the conductivity and thickness of the material. FIG. 2 shows different decays for several conductive materials.

As can be seen from this figure, the signal corresponding to stainless steel prevails for 30 microseconds, the signal corresponding to copper being dominant over the period 40 to 70 microseconds and after 90 microseconds the signal corresponding to aluminum is substantially greater than those of the two preceding metals.

Thus, by measuring and comparing the voltage signals induced in the presence of an unknown target object, at 20, 50 and 100 microseconds, it is easily possible to draw conclusions as to the nature or composition of the material forming or coating said object. This analysis also permits adjusting the sensitivity of the sensor device 2 so as to give identical reactions for all types of materials.

The acquisition of the signal takes place by taking into account at least two measuring points in the portion of the curve of the pertinent signal, preferably at least three points.

The greater the number of points of measurement sampled and processed for their comparison with pre-stored data, the more the detection process will be accurate in terms of sensitivity, precision, reliability and the power to discriminate.

Thus, by using at least three measuring points, it will be possible to determine the nature of a magnetic material, particularly a ferromagnetic material, entering the detection field, even when this material is present as a layer of less than one millimeter.

Similarly, the process permits distinguishing the different layers of strata of several separate ferromagnetic materials.

Finally, the analysis according to the invention, of characteristics of the pertinent portion of the curve of a detection signal given by the material of a layer and its comparison with values resulting from preliminary measurements on different thicknesses of the same material, permits determining the thickness of the layer of analyzed material, in particular when the latter is less than about two millimeters, preferably less than about one millimeter.

Thanks to the arrangements according to the invention and to the characteristics set forth above, it is possible to achieve particularly the following advantages:
the possibility of mounting the detector device 2 in a sealed casing of stainless steel;
the possibility of carrying out the detection at a large distance (up to 20 millimeters through a casing of a thickness of 0.5 millimeters of stainless steel);
the possibility of detection with a factor 1 (which is to say that the distance of detection can be independent from the constituent material of the object to be detected);
excellent temperature stability, thanks particularly to the absence of any oscillating circuit;
the possibility of a high frequency of repetition of the successive detection sequences (up to 5 KHz), because of the very short duration of the phenomenon used.

Of course, the invention is not limited to the embodiment described and shown in the accompanying drawings. Modifications remain possible, particularly as to the construction of the various elements or by substitution of technical equivalents, without thereby departing from the scope of protection of the invention.

1. Process for the detection of an object of an electrically conductive material or at least partially covered with such a material, characterized in that it consists in generated, by means of an inductance (3) correspondingly supplied, a magnetic field adapted to induce Foucault currents in said conductive material, when said object (1) is located at a suitable distance from said inductance (3), in abruptly cutting the supply and the current flowing in said inductance (3), in gathering the voltage and/or current signal induced in said inductance (3) by said Foucault currents after cutting, and in analyzing the characteristics of said signal or signals, particularly their decay, thereby to deduce information relating to the nature and/or thickness of the conductive material of the object (1) detected and/or the distance between said inductance (3) and said object (1).

2. Process according to claim 1, characterized in that supply of the inductance (3) is carried out by means of repetitive voltage pulses, the cutting of the current flowing in the inductance (3) being synchronized with the descending fronts of said pulses.

3. Process according to claim 1, characterized in that it consists in connecting the inductance (3) to a supply unit (4), for example in the form of a pulse signal generator, during the phase of generation of the magnetic field by said inductance (3) forming field emitter means, and in connecting said inductance (3) to means (5 to 7) for acquiring and using voltage signals induced in said inductance, for example in the form of a digitizing module, for processing and evaluation of said signals, during the magnetic induction phase by the decaying Foucault currents in the inductance (3) forming field receiver means, the two said phases being repeated for each signal pulse delivered by the supply unit (4).

4. Process according to claim 1, characterized in that the acquisition of the voltage signal induced in the inductance (3) after cutting the current flowing in this latter, consists in sampling said signal over a time interval extending between 10 microseconds and 150 microseconds, preferably between 20 and 100 microseconds, after said cutting, and in carrying out an analog/digital conversion of the recovered samples.

5. Process according to claim 1, characterized in that the analysis of characteristics of the voltage signal or intensity induced in the inductance (3) consists in determining the shape and the position, on a time diagram, of the curve of said signal at its bent portion or the value of at least certain predetermined points on this curve, in comparing these characteristics with memorized reference characteristics, for example predetermined during a preliminary phase of calibration, and in deducing the nature, composition, mass and/or thickness of the conductive material of the object (1) subjected to the influence of the magnetic field generated by said inductance (3).

6. Process according to claim 1, characterized in that the analysis of the characteristics of the voltage signal or induced intensity consists in integrating said signal over a predetermined time period for duration and offset relative to the instant of cutting, then comparing the resulting integrated value with said memorized reference values, for example predetermined during a preliminary calibration phase, and in deducing thereby the nature, composition, mass and/or thickness of the conductive material of the object (1) subject to the influence of the magnetic field generated by said inductance (3).

7. Process according to claim 1, characterized in that it consists in successively analyzing several induced voltage or current signals associated with several sequences of consecutive detection and in carrying out an overall evaluation of the characteristics of the different signals.

8. Inductive sensor device, adapted to detect and to permit the characterization at least partially of an object of an electrically conductive material, enclosing at least one portion of conductive material or at least partially covered by such a material, characterized in that it principally comprises an inductance (3) disposed in the active portion or surface (2′) of said sensor (2) and adapted to generate a magnetic field adapted to induce Foucault currents in said conductive material, electrical supply means (4) for said inductance (3) and for abruptly cutting the current flowing in this latter, means (5, 6) for acquiring the voltage and/or current signal induced in said inductance (3) by said Foucault currents after cutting, and means (7) for analyzing characteristics of said signal or signals generated by induction thereby to deduce information relating to the nature and/or thickness of the conductive material of the object (1) detected and/or the distance between said inductance (3) and said object (1).

9. Sensor device according to claim 8, characterized in that the electrical supply means (4) consist of a generator for voltage pulses, preferably of rectangular shape, and in that the actuation of the means for cutting the current flowing in the inductance (3) is synchronized with the descending fronts of said pulses.

10. Sensor device according to claim 8, characterized in that the acquisition means comprise means (5) for sampling the induced signal at the terminals of the inductance (3) after cutting and means (6) for analog/digital conversion of the samples provided by said means (5).

11. Sensor device according to claim 8, characterized in that the analysis means (7) comprises means for determining the shape and position of the time curve representative of the induced signal taken at the terminals of the inductance after cutting, means for comparing said characteristics with memorized reference characteristics, and means for deducing the nature, composition, mass and/or thickness of the conductive material of the object (1) subject to the influence of the magnetic field generated by said inductance (3).

12. Sensor device according to claim 8, characterized in that at least one inductance (3) is mounted in a protective housing or casing (8) hermetically sealed, preferably of stainless steel or a similar metallic alloy.
